(19) United States
(12) Patent Application Publication
(10) Pub. No.: US 2005/0053897 A1
(43) Pub. Date: Mar. 10, 2005

(54) Structure of artificial implantable dental

(76) Inventor: Wen-Yuen Wu, Kaohsiung (TW)

Correspondence Address: BACON & THOMAS, PLLC, 625 SLATERS LANE, FOURTH FLOOR, ALEXANDRIA, VA, 22314, US

(21) Appl. No.: 10/654,989

(22) Filed: Sep. 5, 2003

(51) Int. Cl. A61C 8/00

(52) U.S. Cl. 433/173

(57) ABSTRACT

An artificial implantable dental structure comprises an abutment, an implant, and a normal conical body located between the abutment and the implant. The normal conical body serves to minimize an acute angle that is formed by a conical surface of the normal conical body and a top of the gums at the time when the implant is planted in a bone socket of the mouth cavity, thereby preventing deposition of food particles in contact areas of the implant and the gums.

### FIELD OF THE PRESENT INVENTION

The present invention relates generally to dental corrective devices, and more particularly to artificial implantable dental.

### BACKGROUND OF THE PRESENT INVENTION

The existing artificial implantable dental are generally grouped as simple artificial implantable dental and compound artificial implantable dental. The simple artificial implantable dental are made of one part or element, whereas the compound artificial implantable dental are made of two or three separate parts or elements.

As shown in FIGS. 1 and 2, a simple artificial implantable dental 10 of the prior art is provided with an abutment portion 11 and a threaded portion 12. The abutment portion 11 is used to support a restoration tooth “T”. The threaded portion 12 is used to implant the artificial implantable dental 10 and is fastened onto a bone socket “I”, as shown in FIG. 2.

As shown in FIGS. 3 and 4, a compound artificial implantable dental 20 is formed of an abutment 21 and an implantation body 22. The abutment 21 is provided in the upper portion with a supporting structure 211, and in the lower portion with a fastening structure 212. The abutment 21 is joined with the implantation body 22 such that the fastening structure 212 of the abutment 21 is engaged with a fastening structure 221 of the implantation body 22. The supporting structure 211 of the abutment 21 is used to support a restoration tooth “T”.

As shown in FIGS. 5 and 6, an another compound artificial implantable dental 30 is formed of an abutment 31, an implantation body 32, and a fastener 33. The abutment 31 is of a hollow tubular construction. The abutment 31 is provided in the upper portion with a supporting structure for supporting a restoration tooth “T”, and in the lower portion with a fitting structure 312. The implantation body 32 is provided in the top end with a retaining slot 321 for retaining the fitting structure 312 of the abutment 31. The abutment 31 is securely fastened with the implantation body 32 by the fastener 33 which is engaged with a fastening hole 322 of the implantation body 32 through the hollow abutment 31.

Such conventional artificial implantable dental 10, 20, and 30 as described above are defective in design in that they are prone to implantation failure and gums inflammation. As illustrated in FIG. 2, the V-shaped male threads located at the juncture of the abutment portion 11 and the threaded portion 12 of the simple artificial implantable dental 10 form an obtuse angle α1 along with the top of the gums “K”. The compound artificial implantable dental 20 has a tapered portion 212. In light of such a V-shaped construction, the juncture of the supporting structure 211 and the fastening structure 212 (the tapered portion) of the abutment 21 of the artificial implantable dental 20 forms an obtuse angle α2 along with the top of the gums “K”, as illustrated in FIG. 4. Similarly, the fitting structure 312 of the abutment 31 of the compound artificial implantable dental 30 is of a tapered construction. As a result, the fitting structure 312 and the top of the gums “K” form an obtuse angle α3, as shown in FIG. 6. Due to lack of a protective structure existing between the implantation body and the gums, the food particles are apt to deposit between the implantation body and the gums in light of the obtuse angles α1, α2, and α3. The contact areas between the implantation body and the gums are breeding grounds for bacteria which cause inflammation of the gums. The inflammation of the gums undermines the anchorage effect of the artificial implantable dental 10, 20, and 30.

This inventor of the present invention is a licensed dentist and has been practicing dentistry since 1986. In light of lack of improvements on the existing artificial implantable dental, this inventor has done a great deal of research on the structure of artificial implantable dental. This disclosure represents the fruit of research effort of this inventor.

### SUMMARY OF THE PRESENT INVENTION

The primary objective of the present invention is to provide a simple artificial implantable dental which is formed of an abutment and an implantation body. The abutment and the implantation body are made integrality. The abutment is used to support a restoration tooth, whereas the implantation body is used to implant the artificial implantable dental. The simple artificial implantable dental of the present invention is characterized by a normal conical segment which is made integrality with the abutment and the implantation body such that the normal conical segment is located between the abutment and the implantation body. The normal conical segment serves to minimize an acute angle that is formed by the top of the gums and the artificial implantable dental.

It is another objective of the present invention to provide a compound artificial implantable dental which is formed of an abutment and an implantation body. The abutment is used to support a restoration tooth and is fastened with the implantation body which is provided with a normal conical upper portion capable of minimizing an acute angle that is formed by the top of the gums and the artificial implantable dental.

It is still another objective of the present invention to provide another compound artificial implantable dental which is formed of an abutment, an implantation body, and a fastener for fastening the abutment with the implantation body. The implantation body is provided with a normal conical upper portion for minimizing an acute angle that is formed by the top of the gums and the artificial implantable dental.

The features and the advantages of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a schematic view of a simple artificial implantable dental of the prior art.

FIG. 2 shows a sectional schematic view of the prior art simple artificial implantable dental at work.

FIG. 3 shows an exploded view of a compound artificial implantable dental of the prior art.

FIG. 4 shows a sectional schematic view of the prior art compound artificial implantable dental at work.

FIG. 5 shows an exploded view of a second compound artificial implantable dental of the prior art.

FIG. 6 shows a sectional schematic view of the second compound artificial implantable dental of the prior art at work.

FIG. 7 shows a schematic view of a simple artificial implantable dental of the present invention.

FIG. 8 shows a sectional schematic view of the simple artificial implantable dental of the present invention at work.

FIG. 9 shows an exploded view of a first compound artificial implantable dental of the present invention.

FIG. 10 shows a sectional schematic view of the first compound artificial implantable dental of the present invention at work.

FIG. 11 shows an exploded view of a second compound artificial implantable dental of the present invention.

FIG. 12 shows a sectional schematic view of the second compound artificial implantable dental of the present invention at work.

FIG. 13 shows a schematic view of a simple artificial implantable dental of a second preferred embodiment of the present invention.

FIG. 14 shows a sectional schematic view of the simple artificial implantable dental of the second preferred embodiment of the present invention at work.

FIG. 15 shows a schematic view of a first compound artificial implantable dental of a second preferred embodiment of the present invention.

FIG. 16 shows a sectional schematic view of the first compound artificial implantable dental of the second preferred embodiment of the present invention at work.

FIG. 17 shows a schematic view of a second compound artificial implantable dental of a second preferred embodiment of the present invention.

FIG. 18 shows a sectional schematic view of the second compound artificial implantable dental of the second preferred embodiment of the present invention at work.

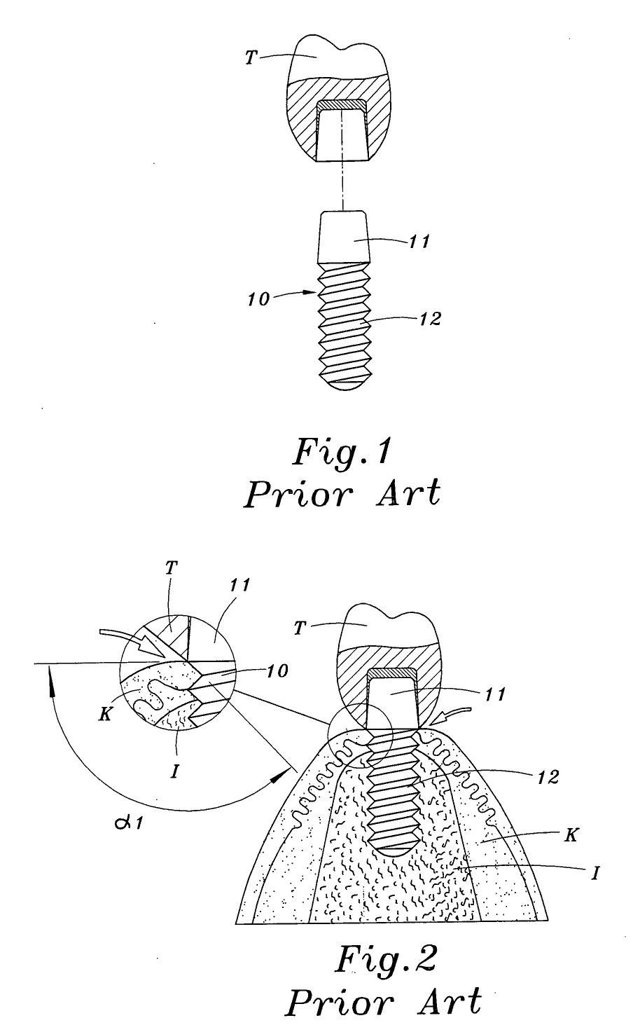

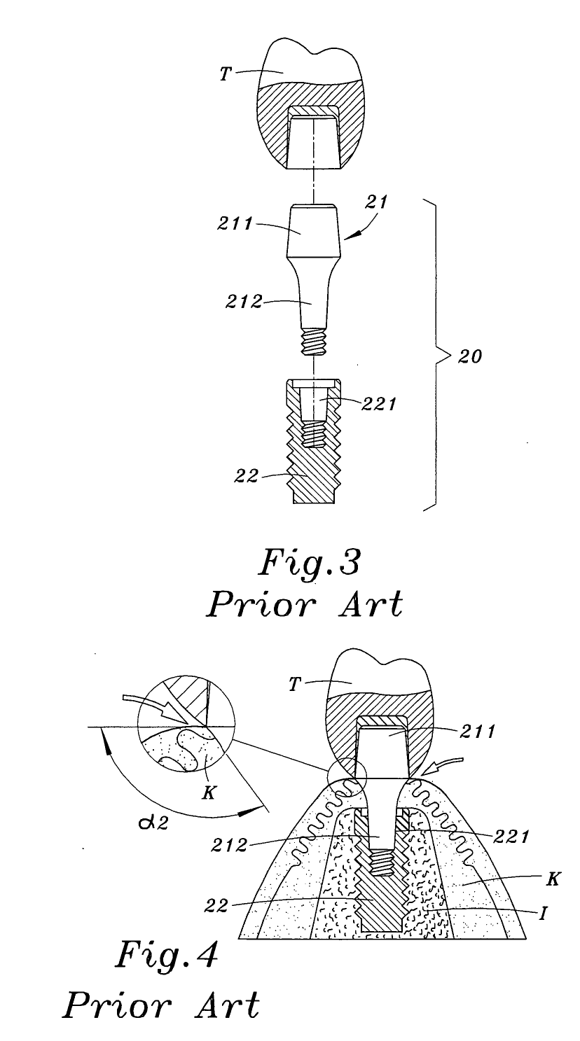

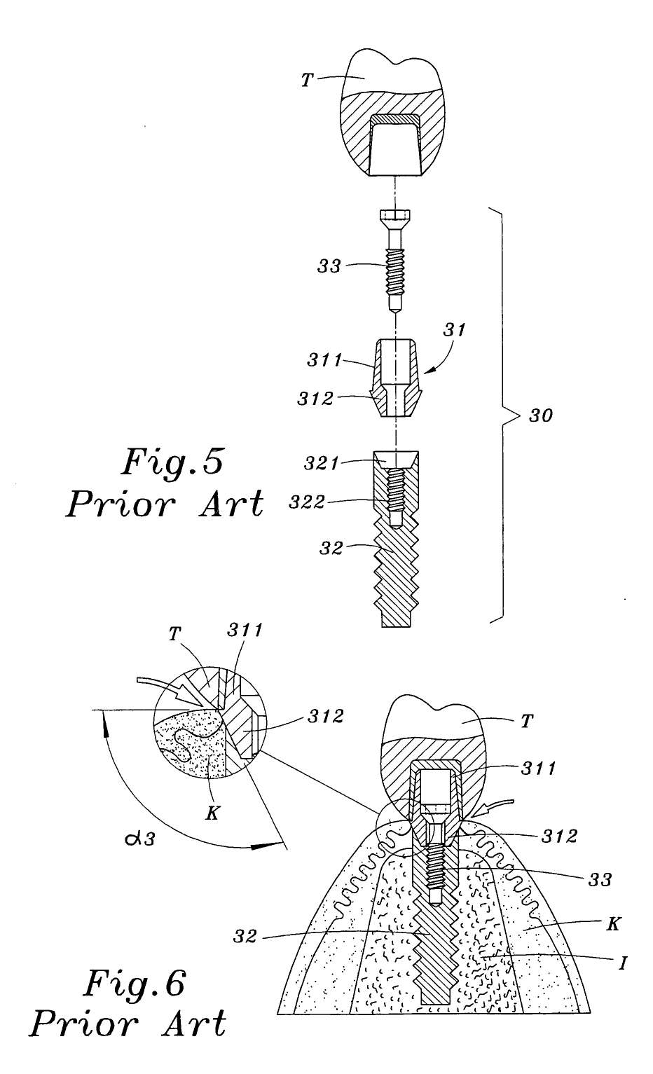

### DETAILED DESCRIPTION OF THE PREFERRED EMBODIMENT

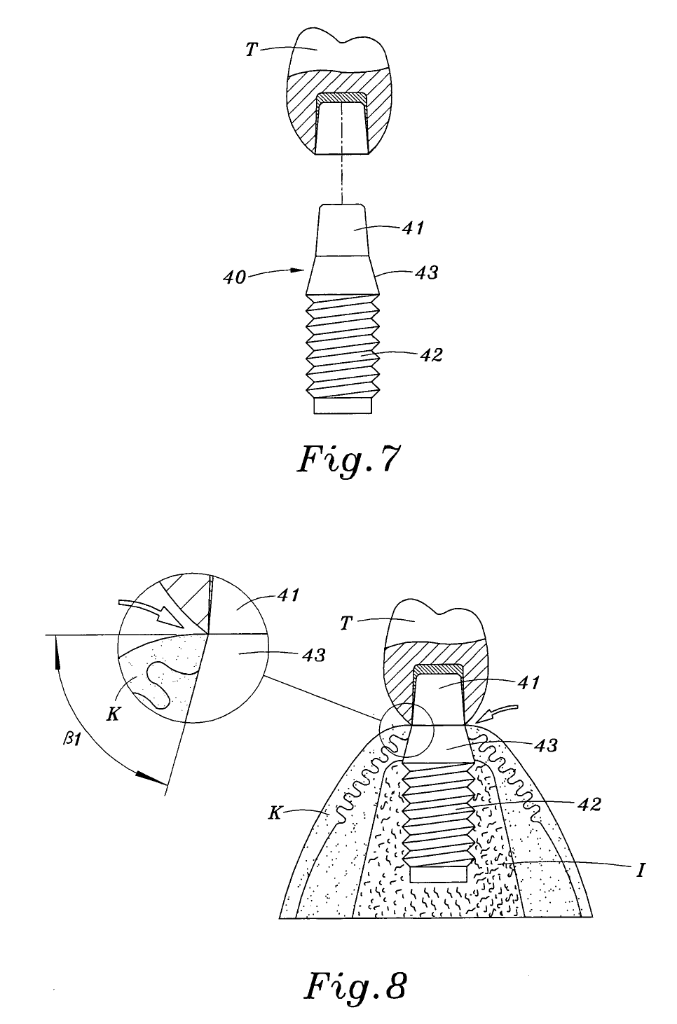

As shown in FIGS. 7 and 8, a simple artificial implantable dental 40 embodied in the present invention has an abutment portion 41, an implantation portion 42, and a normal conical portion 43 located between the abutment portion 41 and the implantation portion 42. The simple artificial implantable dental 40 is made integrality. The abutment portion 41 is used to support a restoration tooth “T”. The implantation portion 42 is implanted in a bone socket “I” such that a bottom edge of the normal conical portion 43 is level with a top of the bone socket “I”, and that a top edge of the normal conical portion 43 is either level with a top of the gums “K”, or located above the top of the gums “K”. The normal conical portion 43 serves to minimize an acute-angle β1 that is formed between the conical portion 43 and the top of the gums “K”, thereby preventing deposition of food particles between the implantation portion 42 and the gums “K”. As a result, the inflammation of the gums is effectively averted. The anchorage effect of the simple artificial implantable dental 40 is greatly enhanced. The high rate of successful implantation of the simple artificial implantable dental 40 of the present invention is thus made possible.

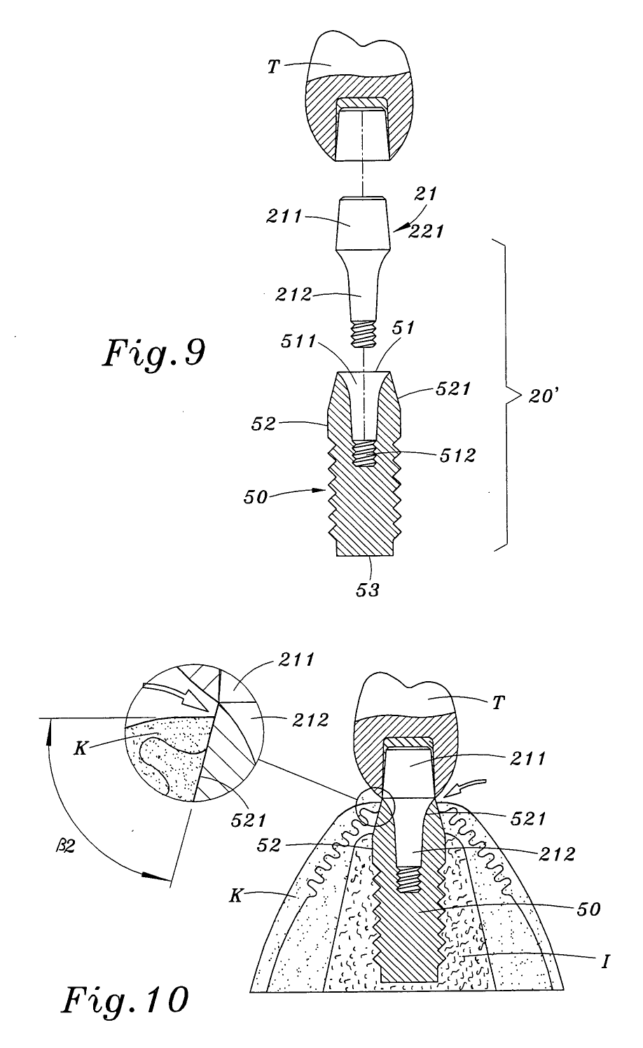

As shown in FIGS. 9 and 10, a first compound artificial implantable dental 20′ embodied in the present invention is formed of an abutment body 21 and an implantation body 50. The abutment body 21 has an upper portion 211 for supporting a restoration tooth “T”, and a lower portion 212 which is fastened with the implantation body 50. The implantation body 50 has a top 51, an outer surface 52, and a bottom 53. The top 51 is provided with a slot 511 which is provided at the bottom end thereof with a threaded hole 512 for engaging a threaded end of the lower portion 212 of the abutment body 21. The outer surface 52 is provided with a normal conical surface 521. The artificial implantable dental 20′ is implanted in a bone socket “I” such that the bottom edge of the normal conical surface 521 is level with a top of the bone socket “I”, and that the top edge of the normal conical surface 521 is level with a top of the gums “K”, or located above the top of the gums “K”. The normal conical surface 521 and the top of the gums “K” form an acute angle of β2, which is relatively small. In another words, the normal conical surface 521 serves to minimize the obtuse angle β2 so formed, so as to obstruct the intrusion of food particles into the contact areas between the implantation body 50 and the gums “K”. As a result, the inflammation of the gums is averted. Meanwhile, the anchorage effect of the artificial implantable dental 20′ of the present invention is enhanced.

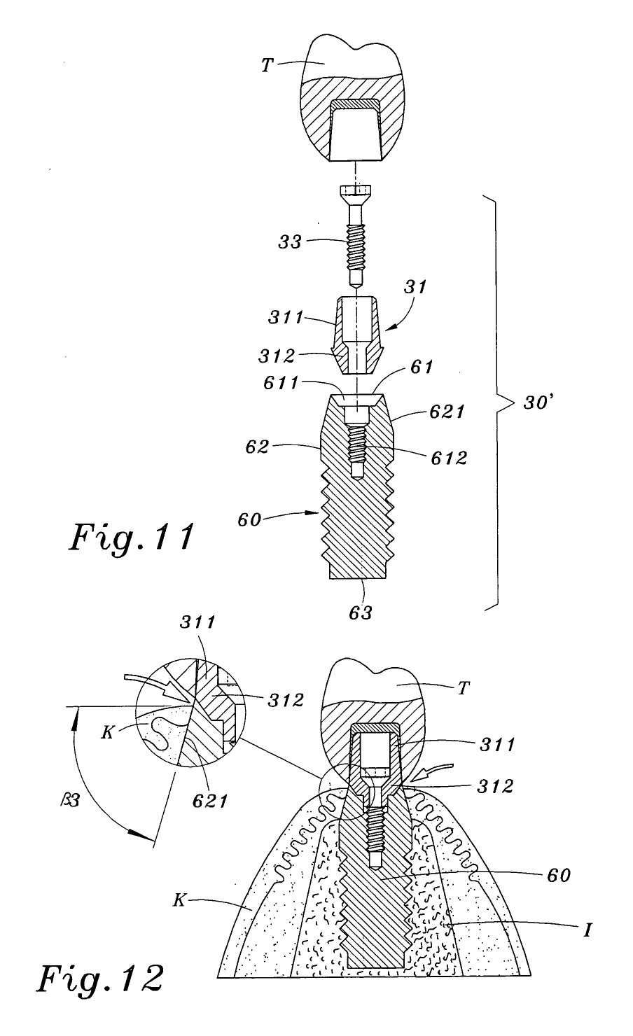

As shown in FIGS. 11 and 12, a second compound artificial implantable dental 30′ embodied in the present invention is formed of an abutment body 31, an implantation body 60, and a fastener 33. The abutment body 31 is provided in the center with an axial through hole, and provided with an upper portion 311 for supporting a restoration tooth “T”, and a lower portion 312 which is fitted into a retaining slot 611 of a top 61 of the implantation body 60. The implantation body 60 has an outer surface 62 and a bottom 63. The outer surface 62 is provided with a normal conical surface 621 adjoining the top 61 of the implantation body 60. The abutment body 31 is fastened with the implantation body 60 by the fastener 33 which is engaged with a fastening hole 612 of the implantation body 60. The implantation body 60 is implanted in a bone socket “I” such that the bottom edge of the normal conical surface 621 is flush with a top of the bone socket “I”, and that the top edge of the normal conical surface 621 is located above a top of the gums “K”, or flush with the top of the gums “K”. The normal conical surface 621 and the top of the gums “K” form an acute angle of β3, which is relatively small to effect the obstruction of deposition of food particles between the implantation body 60 and the gums “K”. As a result, the second compound artificial implantable dental 30′ of the present invention is successfully implanted without any unwanted side effect.

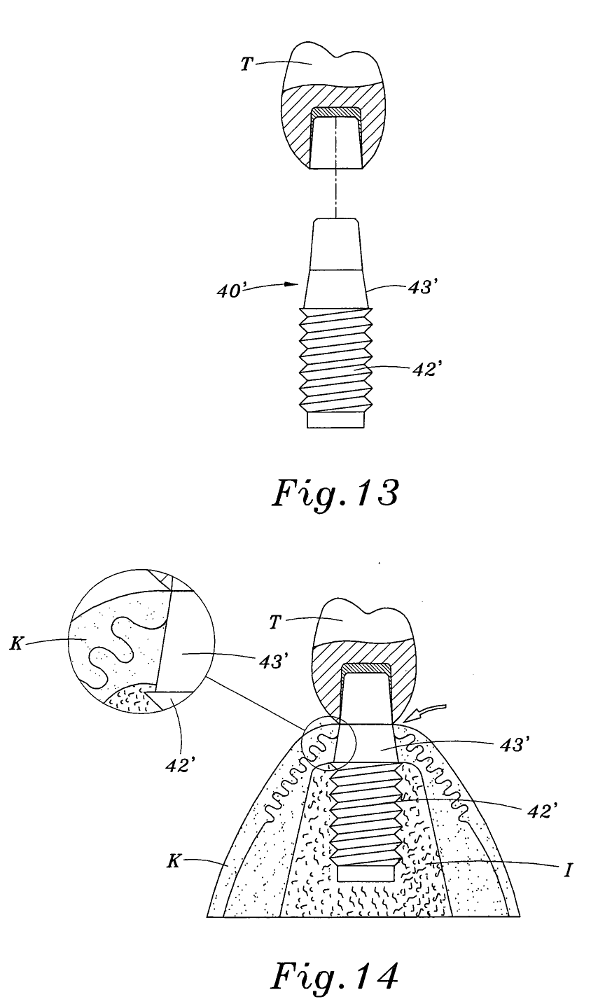

As shown in FIGS. 13 and 14, a simple artificial implantable dental 40′ of the second preferred embodiment of the present invention has an implantation portion 42′ and a normal conical portion 43′. The artificial implantable dental 40′ further has a stepped portion located between the bottom edge of the normal conical portion 43′ and the top edge of the implantation portion 42′. The stepped portion forms a second barrier serving to prevent entry of bacteria into the contact areas between the implantation portion 42′ and a bone socket “I”, as illustrated in FIG. 14.

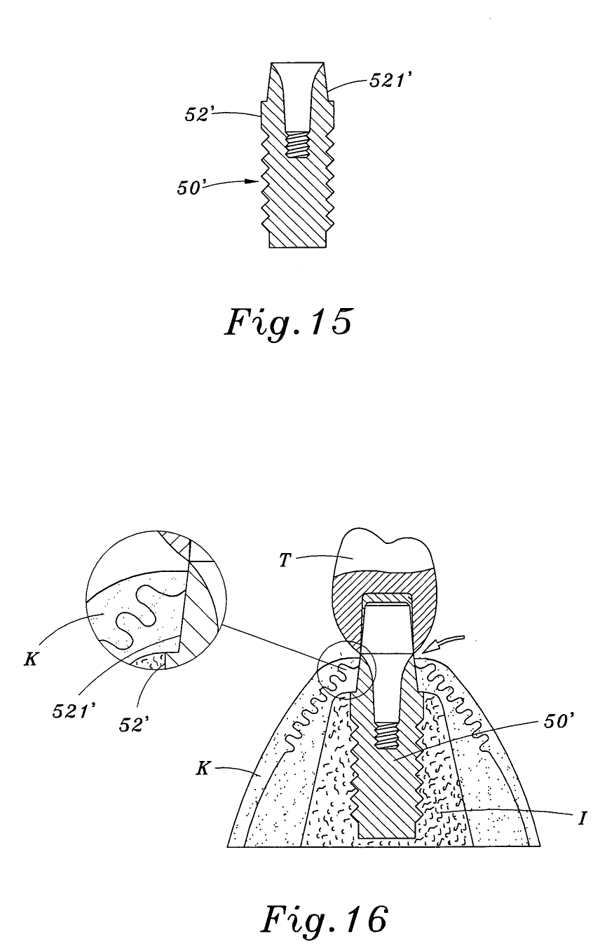

As illustrated in FIGS. 15 and 16, a compound artificial implantable dental of the second preferred embodiment of the present invention comprises an implantation body 50′, which is provided with a stepped portion located between the bottom edge of the normal conical surface 521′ thereof and the outer surface 52′ thereof The stepped portion serves as a second barrier to avert the entry of bacteria into the contact areas between the implantation body 50′ and a bone socket “I”, as shown in FIG. 16.

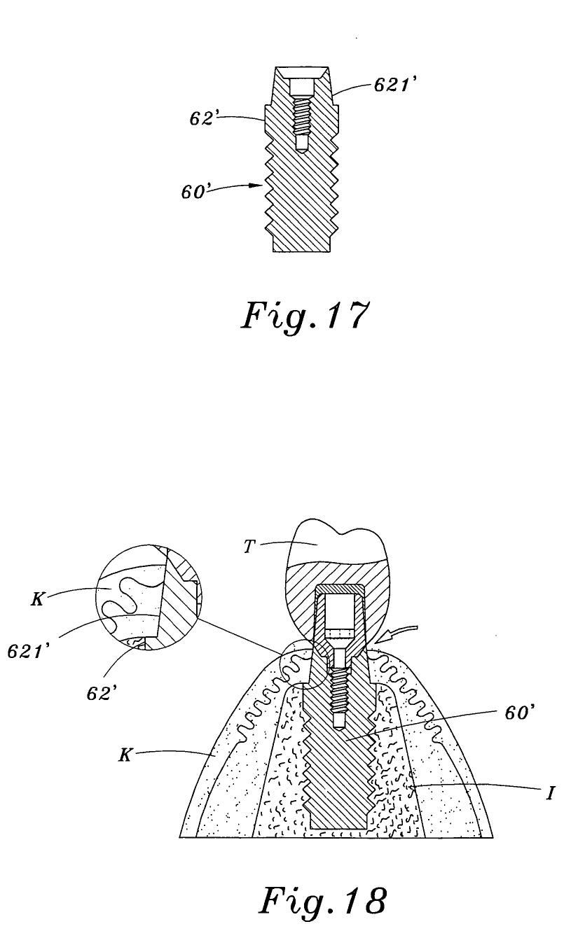

As shown in FIGS. 17 and 18, another compound artificial implantable dental of the second preferred embodiment of the present invention comprises an implantation body 60′, which is provided with a stepped portion located between the bottom edge of the normal conical surface 621′ and the outer surface 62′. The stepped portion serves as a second barrier to avert the entry of bacteria into the contact areas between the implantation body 60′ and a bone socket “I”, as shown in FIG. 18.

The embodiments of the present invention described above are to be regarded in all respects as being illustrative and nonrestrictive. Accordingly, the present invention may be embodied in other specific forms without deviating from the spirit thereof The present invention is therefore to be limited only by the scopes of the following claims.

1. A simple artificial implantable dental, comprising:
an abutment portion which supporting a restoration tooth; and
an implantation portion and a normal conical portion located between the abutment portion and the implantation portion.

2. A simple artificial implantable dental, as recited in claim 1, wherein said implantation portion is provided with male threads.

3. A simple artificial implantable dental, as recited in claim 1, wherein said normal conical portion further having a stepped portion whereby said stepped portion is located between a bottom edge of said normal conical portion and a top edge of said implantation portion.

4. A compound artificial implantable dental, comprising:
an abutment body has an upper portion for supporting a restoration tooth, and a lower portion which is fastened with the implantation body; and
an implantation body which have a top, an outer surface, and a bottom, said top being provided with a retaining slot which is provided at a bottom thereof with a threaded hole, said outer surface being provided with a normal conical surface.

5. A compound artificial implantable dental, as recited in claim 4, wherein said implantation body is provided in a lower portion thereof with male threads.

6. A compound artificial implantable dental, as recited in claim 4, wherein said implantation body is further provided with a stepped portion whereby said stepped portion is located between a bottom edge of said normal conical surface and said outer surface.

7. A compound artificial implantable dental, comprising:
an abutment body is provided in the center with an axial through hole, and provided with an upper portion and a lower portion, wherein said upper portion is provided for supporting a restoration tooth;
an implantation body which have a top, an outer surface, and a bottom, the top being provided with a slot which is provided in a bottom thereof with a fastening hole whereby the outer surface is provided with a normal conical surface; and
a fastener for fastening the abutment body with the implantation body.

8. A compound artificial implantable dental, as recited in claim 7, wherein said implantation body is provided in a lower portion with male threads.

9. A compound artificial implantable dental, as recited in claim 7, wherein said implantation body further provided with a stepped portion located between a bottom edge of said normal conical surface and said outer surface of said implantation body.
